(19) United States
(12) Patent Application Publication
(10) Pub. No.: US 2026/0288092 A1
(43) Pub. Date: Sep. 24, 2026

(54) Method and Apparatus for Training a Machine Learning System

(71) Applicant: Robert Bosch GmbH, Stuttgart (DE)

(72) Inventors: Felix Berkel, Schifferstadt (DE); Kim Peter Wabersich, Schwaebisch Gmuend (DE); Nicolas Chatzikiriakos, Boeblingen (DE)

(21) Appl. No.: 19/477,922

(22) PCT Filed: Apr. 22, 2024
(86) PCT No.: PCT/EP2024/060948

§ 371 Date: Oct. 23, 2025

(30) Foreign Application Priority Data
Apr. 24, 2023 (DE) 10 2023 203 744.0

(51) Int. Cl. G05B 13/02; G05B 13/04

(52) U.S. Cl. CPC G05B 13/027; G05B 13/048

(57) ABSTRACT

A computer-implemented method for training a machine learning system for use in model predictive control of a technical system is disclosed. The machine learning system is configured to determine, with respect to an operating state and/or an environmental state of the technical system to be controlled, a value that characterizes a quality of said state. The method includes (i) determining a plurality of operating states and/or environmental states of the technical system to be controlled, (ii) determining a quality value of a state of the plurality of operating states and/or environmental states, wherein the quality value characterizes a quality of the state with respect to a model predictive control, and (iii) training the machine learning system through supervised training of the machine learning system, wherein the state is used as input to the machine learning system and the determined quality value is used as desired output of the machine learning system.

### TECHNICAL FIELD

The invention relates to a method for training a machine learning system, a method for model predictive control of a technical system, a training system, a control system, a computer program, and a machine-readable storage medium.

### PRIOR ART

Zeilinger et al. “Soft Constrained Model Predictive Control With Robust Stability Guarantees”, 2014, https://ieeexplore.ieee.org/abstract/document/6730917/discloses a method for model predictive control of a technical system.

### Advantages of the Invention

Model predictive control (MPC) is a key method for technical systems. In known approaches for model predictive control, an optimal control problem is formulated and solved at each sampling time. In this optimization problem, the future behavior of the system is predicted over a finite time horizon, starting from a current state measurement of the system and using a model of the system. One advantage of model predictive control over other advanced control methods is that model predictive control can optimally handle systems having multiple inputs and outputs and system constraints can be systematically incorporated. Both advantages are used, for example, in the movement control of vehicles. For example, the vehicle must comply with road limits and steering, acceleration and braking must be coordinated to ensure safe and efficient operation. The model predictive control has proven its high performance in many studies and at the same time offers strict safety guarantees.

When model predictive control is used, an optimal control problem is typically defined at a current time and state, which determines an optimal sequence of control signals of the system for a finite number of future states by means of a model of the system to be controlled. To this end, an optimization problem is typically solved at each point in time and thus for each state, wherein optimization is carried out through (with respect to) the control signals. The main challenge arises from the requirement that the optimization problem must be solved in real time for the control of technical systems in order to ensure sufficiently accurate control.

Known solutions to solve the optimization problem work iteratively. A drawback of these approaches is that the number of iterations available is typically not sufficient to determine an exact solution to the optimization problem while remaining real-time capable. The effects of an application of a control signal, which was determined based on such a sub-optimal solution to the optimization problem, generally does not allow the capability to estimate how the system to be controlled behaves, in particular with respect to safety-critical behavior of the system.

The inventors surprisingly found that solving the optimization problem for model predictive control can be approximated with extreme accuracy through machine learning methods. This allows an accurate determination of the solution at the runtime of a model predictive control. The inventors were further able to determine that by approximating an adjusted optimization problem under slip variables, a stability of the control signal to state of a technical system can be ensured and that the secondary conditions of the model predictive control defined in the original optimization problem are complied with.

### DISCLOSURE OF THE INVENTION

In a first aspect, the invention relates to a computer-implemented method for training a machine learning system for use in model-predictive control of a technical system, wherein the machine learning system is configured to determine, with respect to an operating state and/or an environmental state of the technical system to be controlled, a value that characterizes a quality of said state, the method comprising the steps of:
determining a plurality of operating states and/or environmental states of the technical system to be controlled;
determining a quality value of a state of the plurality of operating states and/or environmental states, wherein the quality value characterizes a quality of the state with respect to a model predictive control;
training the machine learning system through supervised training of the machine learning system, wherein the state is used as input to the machine learning system and the determined quality value is used as desired output of the machine learning system.

Operating states and/or system states are also simply referred to as states in the following. A state of a technical system can in particular be understood as being completely measurable or at least observable in terms of control technology. For example, it is possible for at least parts of a state to be measured by means of sensors of the system to be controlled or to be derived based on sensor recordings (also referred to as indirect measurement). For example, it is possible that a mobile robot is to be controlled, which captures images of its environment using a camera. Based on these images, as at least part of a state of the robot, it can be determined how far the robot deviates from a travel trajectory defined in the environment of the robot.

The machine learning system may be used after training, in particular within a policy, to assess a quality of a future state. Based on this rating, a control signal for the technical system may then be selected, which has a best quality with respect to a plurality of possible control signals.

The method of training can be understood such that training data is first collected, with which the machine learning system is subsequently supervised. Data sets of tuples are generally used for the supervised training, wherein each tuple comprises an input signal and a desired output signal. During the supervised training, the machine learning system is adapted to output an output signal as close as possible to the desired output signal when the machine learning system receives the input signal as input. For the method of training, a state may be understood as an input signal used for training. Such an input signal may in particular be determined by recording states of the system during operation of the system. Alternatively, it is also possible that the states are generated synthetically, for example based on a rasterization of physically meaningful values of a state.

A quality measure is then determined for the training for at least one state. The quality measure may be understood as annotation or desired output signal within the meaning of the supervised training. The quality degree is determined in this respect with regard to a model predictive control.

In particular, the quality value is determined based on a value function of the model-predictive control, wherein the value function determines a quality of the state relating to a state and the value function further comprises secondary conditions, wherein a secondary condition characterizes a physical constraint of the state and/or a secondary condition characterizes a constraint of a control signal that can select the model-predictive control.

For example, a state may characterize an acceleration of the system, wherein the acceleration cannot exceed a certain value due to engines being used in the system. In that case, the secondary condition may characterize this value.

The states used for the method can in particular be determined by the system that is to be model predictively controlled based on the machine learning system. For example, the system may be placed in a test operation in which another control is used and typical states are determined by the test operation. The system may also be placed under unusual operating conditions to determine states that simulate the boundary regions of a typical control. Alternatively or additionally, it is also possible that possible states of the system are determined in a simulated manner, e.g. by means of a computer simulation of the system. The possibilities mentioned herein for determining the states can also be applied to identical or construction-like systems. For example, it is possible that a prototype or a system that is identical in construction or similar in construction to be controlled is used to determine states that are expected to occur in the system in this way or in a similar way.

In particular, a state may be understood as an amount of values describing physical parameters of the system and/or an environment of the system.

Preferably, a state of the system may be characterized by a vector of real numbers. Thus, the term “determining a plurality of operating states and/or environmental states of the technical system to be controlled” may also be equivalently replaced with “determining a plurality of states of the technical system to be controlled.” Each state of the plurality of states may be understood as a vector of values, wherein each value characterizes an operating state or environmental state of the system.

The value function can in particular characterize the solution of an optimization of a convex function, wherein the function characterizes the costs of a control of the technical problem, i.e. the function can be understood as a cost function.

Advantageously, the solution of the optimization may be determined prior to utilizing the model predictive control of the system (offline). This makes it possible to determine the quality value very precisely, since there are no time requirements for the real-time capability of the optimization.

The method of machine learning is advantageously subsequently trained to predict a quality value with respect to a state. This prediction may be understood as an approximate solution to the optimization problem. The inventors have found that even when using machine learning systems with low requirements for resources and computing capabilities, the prediction of the quality value is still accurate enough to perform model predictive control.

The optimization can in particular be a minimization, wherein a quality value determined by the minimization can be understood to mean that a lower value has a higher quality. The quality value may therefore be understood as a cost value, with lower costs having a higher quality, in other words, a state with lower cost is better than a second state with higher cost.

In various embodiments of the invention, the value function may comprise a secondary condition that permits a numerical deviation of a state from a physical constraint by means of a slip variable.

By means of the slip variables, the secondary conditions of the optimization problem are relaxed in terms of a mathematical optimization. This can advantageously determine a sufficiently exact solution of the optimization problem even for challenging control tasks. The inventors have found that this improves the performance of the machine learning system because the slip variables allow for higher generalization capability of the machine learning system by the relaxation. It is in particular also possible that several secondary conditions are present with slip variables.

In particular, it is advantageous that the cost function comprises a term that characterizes a sum of amounts of the slip variables. Advantageously, the solution of the optimization problem can thus take into account that slip variables cannot become as large as desired and thus solutions that lie well outside the permissible constraints of the secondary conditions can be determined. The term can in particular be multiplied by a factor which can be understood as a hyperparameter of the optimization problem and controls the influence of the slip variables.

In vectorial states, the constraints and the slip variables may in particular also be in the form of vectors. In these cases, the term of the cost function may in particular comprise a sum of the lengths or squared lengths of the slip variables.

In particular, it is possible that a secondary condition of the optimization problem further provides a factor that enhances the physical restriction of the state.

The inventors have advantageously found that reinforcing the constraint results in the later model predictive control for which the machine learning system is used becoming more resilient to errors that occur by approximation of the optimization problem by the machine learning system.

Using the factor used for the slip variables and the factor used for the physical restriction, it can in particular be shown that the secondary conditions are also complied with under errors that occur during approximation of the quality value by the machine learning system if the machine learning system for determining the quality value in the model predictive regulation is used instead of an exact solution to the optimization problem.

In the various embodiments of the method for training, it is possible that in the step of training, the machine learning system is trained at least until an approximation quality criterion is satisfied, wherein the approximation quality criterion characterizes an amount of difference of a value determined for a state from the value function and a value determined for the state from the machine learning system.

The approximation quality criterion may be understood to mean that the machine learning system is evaluated to determine to what extent it is able to determine equal values for a state as also determined by the value function. As long as approximation is not yet sufficiently good, the machine learning system can be further trained. In addition, if the quality criterion has not yet been complied with after a predefined number of iterations, it is possible that additional training data is collected for the method or the machine learning system is increased in the number of its degrees of freedom, for example by increasing the number of parameters of the machine learning system. In particular, if a neural network is used as a machine learning system, an architecture of the neural network may be altered such that the neural network becomes deeper and/or layers of the neural network have more parameters.

Advantageously, the inventors have found that if the approximation quality criterion is met, it can be ensured that the secondary conditions of the value function are met when using the machine learning system despite approximation errors. This causes the approximation found to enable a verifiably reliable control of the technical system using the machine learning system.

In a further aspect, the invention relates to a computer-implemented method for model predictive control of a technical system comprising the steps of:
determining an operating state and/or an environmental state of the system;
determining a control signal for the system, wherein the control signal is determined based on a policy, wherein the policy comprises a term \tilde{V}_{MPC}(f(x,u)), wherein \tilde{V}_{MPC} characterizes an output of a machine learning system, when it receives the input f(x,u), wherein f is a model, preferably a linear model, of the system, and predicts a next operating state and/or system state of the system based on the determined operating state and/or environmental state x and a control signal u, wherein the machine learning system has been further trained;
controlling the system using the determined control signal.

The concept of a policy is generally better known under the English term policy. The policy can essentially be understood as a function that determines a control signal with respect to a state of the system to be controlled by means of which the system is to be controlled.

In the method for model predictive regulation, the policy can in particular be formulated as a further optimization problem. As a control signal, the control signal which, when applied to the current state, can be selected that results in a state with the highest possible quality.

In particular, to determine the next state to which a control signal results based on a current state, linear model of the form

$$x ( k + 1 ) = f ( x ( k ) , u ( k ) ) = A x ( k ) + B u ( k )$$

can be used, wherein x(k) is a state at a time k, u(k) is a control signal at the timek, and A and B are matrices.

Advantageously, by using the machine learning system, the execution of the method can be significantly accelerated, since optimization no longer has to be performed under secondary conditions in order to determine the quality of a state, but the quality can be determined by means of the machine learning system.

The optimization problem in the method for model predictive control may further comprise a term that characterizes a magnitude of the control signal.

Advantageously, a quality of the state to be achieved and an influence of the regulation on the system can be weighed if both terms emerge in the optimization problem. This prevents any possible oscillation of the system by excessively large control signals, but can also lead to a softer control, for example when controlling motors, which contributes to less load and wear on the motors and thus the system to be controlled.

In the methods described above, the machine learning system may in particular be or comprise a neural network.

The inventors could determine that the use of neural networks leads to best approximation of the quality of a state. However, it is also possible to use other machine learning methods. Particularly for simpler control tasks with few secondary conditions or small state space or when using on embedded hardware, even more resource-conserving methods, such as a linear regression or support vector machines, can be used.

Embodiments of the invention are explained in greater detail below with reference to the accompanying drawings. The drawings show:

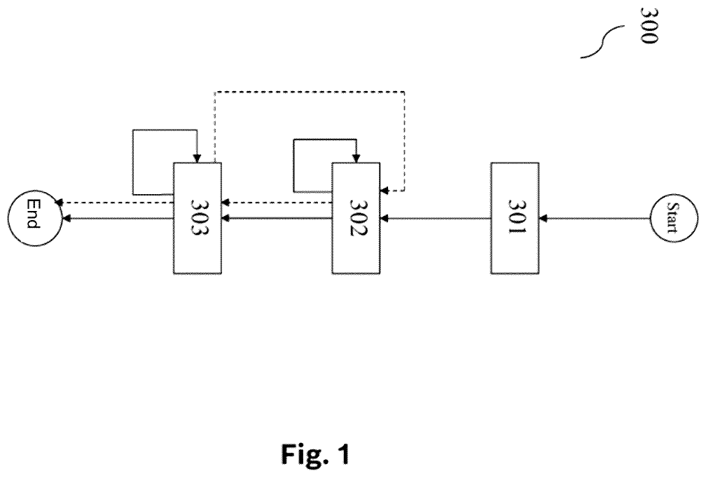

FIG. 1 schematically illustrates a method for training the machine learning system;

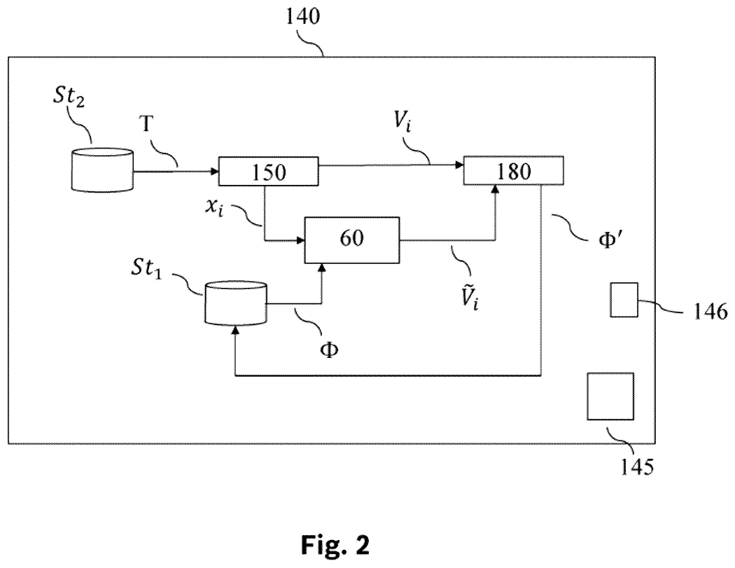

FIG. 2 schematically illustrates a training system;

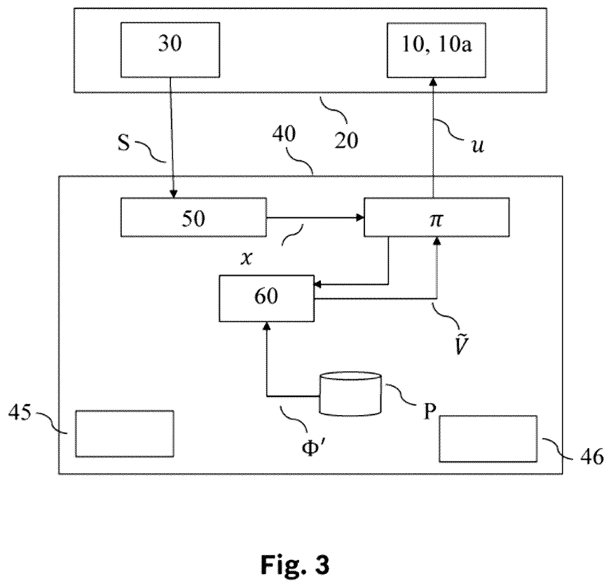

FIG. 3 schematically illustrates a design of a control system for controlling a technical system;

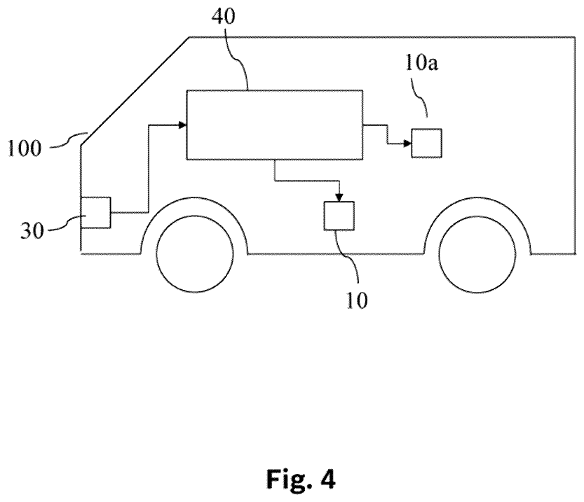

FIG. 4 schematically illustrates an exemplary embodiment for controlling an at least semiautonomous robot;

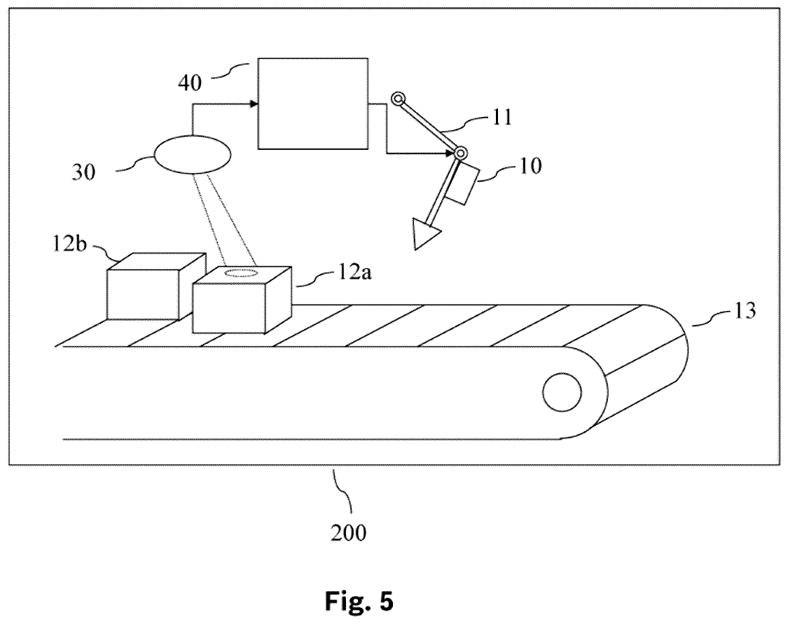

FIG. 5 schematically illustrates an exemplary embodiment for controlling a manufacturing system; and

### DESCRIPTION OF THE EXEMPLARY EMBODIMENTS

FIG. 1 schematically shows the flow of a method (300) for training a machine learning system, wherein the machine learning system can be used in model predictive control of a technical system after training.

In a first step (301), a plurality of states of the technical system to be controlled is determined. The states may preferably be determined by operating the technical system, in which at least one state of the system is preferably determined at regular intervals at different times of operation. In particular, a state may be understood as an operating state and/or an environmental state of the system. The plurality of states is preferably determined by means of a sensor, so a state is preferably respectively a result of a measurement by means of a sensor. Alternatively, a state may be determined based on an indirect measurement. An indirect measurement may be understood as a measurement determined from a physical measurement by means of a sensor or a previous indirect measurement and is not directly discernible in the original measurement from the numerical values of the measurement. For example, an environmental state of the system may characterize a position of an object in an environment of the system. For example, the object may be recorded as an image using a camera and the position of the object may be determined based on object detection of the object within the image, intrinsic and extrinsic camera parameters. In this case, the image may be understood as a direct measurement whose values are the pixel values of the image and the position of the object as an indirect measurement derived from the pixel values (of the direct measurement).

In particular, a state may also characterize multiple physical properties. For example, a state may characterize positions of various objects in the environment of the system and/or a position of the system.

The plurality of states may additionally or alternatively also be determined based on simulation. For example, a physical model of the system may be provided, which then simulates profiles of states of the system. Alternatively or additionally, it is also possible to scan a state space via a grid and to use the states determined in the plurality of states.

Alternatively or additionally, it is also possible for states of the plurality of states to be determined based on a prototype of the system, a construction identical or a construction-like system of the system.

For determined states, preferably for all determined states, each quality value is determined in a second step (302), wherein a quality value characterizes a quality of a state with respect to a model predictive control. The quality values are preferably determined based on an optimization problem, wherein the optimization problem characterizes an optimal model predictive control. The optimization problem is preferably determined by the formula

$$V ( x ) = {min}_{{u}_{\cdot \vert k} , {x}_{\cdot \vert k} , {ξ}_{\cdot \vert k}} J ( {u}_{\cdot \vert k} , {x}_{\cdot \vert k} , {ξ}_{\cdot \vert k} )$$

$$u . d . {Nx}_{0 \vert k} = x ( k ) ,$$

$${x}_{N \vert k} ∈ α {X}_{f}$$

$$α {X}_{f} ⊆ \{ x \vert {H}_{x} x < {h}_{x} ( 1 - η ) + {ξ}_{N \vert k} \} ,$$

$$0 \leq α \leq 1 ,$$

$$∀ i ∈ \{ 0 , … N - 1 \} :$$

$$0 \leq {ξ}_{i \vert k} ,$$

$${x}_{i + 1 \vert k} = {Ax}_{i \vert k} + {Bu}_{i \vert k} ,$$

$${H}_{u} {u}_{i \vert k} \leq {h}_{u} ,$$

$${H}_{x} {x}_{i \vert k} \leq {h}_{x} ( 1 - η ) + {ξ}_{i \vert k} + {ξ}_{N \vert k}$$

Starting from a current state x, the optimization variables are: the sequence of control signals of the system

$${u}_{\cdot \vert k} = {\{ {u}_{i \vert k} \}}_{i = 0}^{N - 1}$$

determined by the model predictive control, the sequence of subsequent states

$${x}_{\cdot \vert k} = {\{ {x}_{i \vert k} \}}_{i = 0}^{N}$$

predicted from the sequence of control signals, and a sequence of optional but preferred slip variables

$${ξ}_{\cdot \vert k} = {\{ {ξ}_{i \vert k} \}}_{i = 0}^{N}$$

with which the constraints of the sequence of optional but preferred slip variables optimization problem can be relaxed. The cost function J is preferably characterized by the formula

$$J ( {u}_{\cdot \vert k} , {x}_{\cdot \vert k} , {ξ}_{\cdot \vert k} ) = {x}^{T} Px + ρ ‖ {ξ}_{N \vert k} ‖ + {\sum }_{i = 0}^{N - 1} l ( {x}_{i \vert k} , {u}_{i \vert k} ) + ρ ‖ {ξ}_{i \vert k} + {ξ}_{N \vert k} ‖ ,$$

$$l ( x , u ) = {x}^{T} Qx + {u}^{T} Ru .$$

The matrices Hᵤ, Hₓ, Q and R are hyperparameters of the optimization problem. The index |k indicates that a reference is made to a point in time k from a point in time. For example, x_{i|k} is the predicted state for the time point i, predicted at the time point k. The secondary condition Hᵤu_{i|k}≤hᵤ characterizes a constraint of the control signal at any time point i from the time point k. The secondary condition

$${H}_{x} {x}_{i \vert k} \leq {h}_{x} ( 1 - η ) + {ξ}_{i \vert k} + {ξ}_{N \vert k}$$

represents a preferred secondary state that further enhances a constraint hₓ of a state x_{i|k} via the factor η. The factors η and ρ may be understood as interacting hyperparameters that weight the degree of relaxation of the optimization problem (via ρ) against robustness compared with the approximation error (via η). The formula x_{i+1|k}=Ax_{i|k}+□_{i|k} characterizes a linear model of the system to be controlled, which predicts a state transition from a time point i to a subsequent time i+1 based on a current state x_{i|k} and a control signal u_{i|k}, i.e. the subsequent state. The variable N characterizes the predictive horizon of the model predictive control, in other words, how far the model predictive control looks into the future.

The states are standardized in the exemplary embodiment so that a state can characterize a deviation from a desired state. In other words, the goal of optimization may in particular be to achieve a state corresponding to the zero vector. It is also possible that other states are controlled. For example, a suitable transformation can be used to transform a desired state in such a way that the transformed state is controlled to the zero vector and thus the control point is determined by the transformation.

The optimization problem can be used to determine a quality value for each of the determined states as the result of the optimization with regard to a state. Preferably, such a quality value is determined for all determined states, thereby determining a data set each comprising pairs of states and associated quality values.

This data set may be used in a third step (303) for supervised training of the machine learning system.

Optionally, the machine learning system (60) may also be trained in batches using an iterative method (batched training). In this case, a subset of states may also be determined from the set of states, and a quality value may be determined for each state before the subset determined in this way (this optional embodiment is indicated by dashed lines in FIG. 1).

Preferably, the machine learning system (60) is trained at least until an approximation quality criterion is satisfied, wherein the approximation quality criterion characterizes an amount of a difference of a value function determined for a state of the value function and a value determined for the state of the machine learning system. In particular, the approximation quality criterion may be characterized by the formulas,

$$∀ x ∈ X : 4 ‖ \tilde{V} ( x ) - V ( x ) ‖ + {V}_{m ax} \leq η \cdot ρ ,$$

$${V}_{m ax} = N ( ‖ Q ‖ \cdot ‖ X ‖ + ‖ R ‖ \cdot ‖ U ‖ ) + ‖ Q ‖ \cdot ‖ X ‖ ,$$

$$‖ X ‖ = {max}_{x ∈ X} ‖ x ‖ ,$$

$$‖ U ‖ = {max}_{u ∈ U} ‖ u ‖$$

wherein \tilde{V}(x) is the prediction of the machine learning system (60) for state x. Preferably, the quality criterion may also be simplified and a subset of states of the state space may be selected instead of considering all states (indicated by the expression ∀x). For example, the subset may be determined by a rasterization of the state space.

FIG. 2 shows an exemplary embodiment of a training system (140) set up to perform the third step (303) of the method (300) shown in FIG. 1. The machine learning system (60) is trained by means of a training data set (T) each comprising tuples of states (xᵢ) and associated quality values (Vᵢ).

For the training, a training data unit (150) accesses a computer-implemented database (St₂), wherein the database (St₂) provides the training data set (T). The training data unit (150) preferably randomly determines at least one state (xᵢ) and the quality value (xᵢ) corresponding to the state (Vᵢ) from the training data set (T) and transmits the state (xᵢ) to the machine learning system (60). The machine learning system (60) determines a prediction (\tilde{V}ᵢ) of the quality value (xᵢ) based on the state (Vᵢ).

The quality value (Vᵢ) and the prediction (\tilde{V}ᵢ) are transmitted to a change unit (180).

Based on the quality value (Vᵢ) and the prediction (\tilde{V}ᵢ), new parameters (Φ′) for the machine learning system (60) are then determined from the change unit (180). For this purpose, the change unit (180) compares the quality value (Vᵢ) and the prediction (\tilde{V}ᵢ) by means of a loss function. The loss function determines a first loss value that characterizes how far the quality value (Vᵢ) deviates from the prediction (\tilde{V}ᵢ). A function is selected as the loss function in the exemplary embodiment, which characterizes a square distance of the quality value (Vᵢ) from the prediction (\tilde{V}ᵢ). In alternative exemplary embodiments, other loss functions are conceivable as well.

The change unit (180) ascertains the new parameters (Φ′) based on the first loss value. In this embodiment example, this is done using a gradient descent method, preferably stochastic gradient descent, Adam or AdamW. In other embodiment examples, the training can also be based on an evolutionary algorithm or a second-order optimization.

The ascertained new parameters (Φ′) are stored in a model parameter memory (St₁). The ascertained new parameters (Φ′) are preferably provided as parameters (Φ) to the machine learning station (60).

In other preferred embodiment examples, the described training is iteratively repeated for a predefined number of iteration steps or iteratively repeated until the first loss value falls below a predefined threshold value. Alternatively or additionally, it is also conceivable that the training is terminated when an average first loss value with respect to a test or validation data set falls below a predefined threshold value. In at least one of the iterations, the new parameters (Φ′) determined in a previous iteration are used as parameters (Φ) of the machine learning system (60).

The training system (140) can also comprise at least one processor (145) and at least one machine-readable storage medium (146), which includes instructions that, when executed by the processor (145), prompt the training system (140) to carry out a training method according to any one of the aspects of the invention.

FIG. 3 shows a control system (40) that determines control signals (u) of a system using the machine learning system (60). In the exemplary embodiment, the control signal (u) represents a control signal of an actuator (10) or a display device (10a) of the technical system. At preferably regular time intervals, at least one operating state and/or environmental state of the technical system is sensed in a sensor (30), which may also be given by a plurality of sensors. The sensor signal (S) or, in the case of multiple sensors one respective sensor signal (S), of the sensor (30) is transmitted to the control system (40). The control system (40) thus receives a sequence of sensor signals (S). From these, the control system (40) ascertains control signals (u) which are transmitted to the actuator (10).

The control system (40) receives the sequence of sensor signals (S) of the sensor (30) in an optional receiving unit (50), which converts the sequence of sensor signals (S) into a sequence of states (x) (the sensor signal (S) can alternatively also be adopted directly as a state (x)). For example, the state (x) may be a section or a further processing of the sensor signal (S) or determine the state (x) based on the sensor signal (S) by means of an indirect measurement. In other words, the state (x) is determined depending on the sensor signal (S). The state (x) is transmitted to a policy module (π).

The policy module (π) determines the control signal (u) based on the state (x) and the machine learning system (60). The control module preferably determines the control signal (u) based on a policy, which is preferably characterized by the formula

$$π ( x ) = arg {min}_{u ∈ U} {u}^{T} R u + \tilde{V} ( f ( x , u ) ) .$$

The term \tilde{V}(f(x,u)) characterizes a prediction (\tilde{V}) of a quality value (V) of the state achieved when the control signal x is executed u in the state, in other words, the quality of a state achieved when a control signal u is executed in the state x. The state that is achieved is preferably determined by the same model

$$x ( k + 1 ) = f ( x ( k ) , u ( k ) ) = A x ( k ) + B x ( k )$$

which has already been used to determine the quality value (Vᵢ). The prediction \tilde{V} is performed by the machine learning system (60). In other words, a quality value is predicted for the subsequent state predicted by the linear model by means of the machine learning system (60).

The policy comprises a preferred term u^{T}Ru, which additionally ensures that a subsequent state with the highest quality value is weighed against the control signal (u) to be applied. The matrix R represents a hyperparameter that may preferably be omitted or placed on the unit matrix. The optimization problem can be solved, for example, with derivation-free and/or parallelizable methods such as sampling or rasterizing the search space U of the possible control signals (u). A solution of the optimization problem is then provided as a control signal (u) to the actuator (10) and/or the display device (10a).

The machine learning system (60) is preferably parameterized by parameters (Φ), which are stored in and provided by a parameter memory (P).

The actuator (10) receives the control signals (A), is controlled accordingly and carries out a respective action. The actuator (10) can comprise a (not necessarily structurally integrated) control logic which, from the control signal (A), ascertains a second control signal which is then used to control the actuator (10).

In further embodiments, the control system (40) comprises the sensor (30). In still further embodiments, the control system (40) alternatively or additionally also includes the actuator (10).

In further preferred embodiments, the control system (40) comprises at least one processor (45) and at least one machine-readable storage medium (46) on which instructions are stored that, when executed on the at least one processor (45), prompt the control system (40) to carry out the method according to the invention.

FIG. 4 shows how the control system (40) can be used to control an at least partially autonomous robot, here an at least partially autonomous motor vehicle (100).

The sensor (30) can be a video sensor that is preferably disposed in the motor vehicle (100), for example. The conversion unit (50) may in particular be set up to determine a drivable area, for example a road or a lane of a multi-lane road. The state (x) may then in particular characterize a deviation of the robot (100) from a desired position on the movable area, for example a deviation of a center point of the robot from a center point of the movable area. The state (x) may additionally comprise longitudinal and lateral accelerations of the robot. The state can additionally comprise a slip of a moving means of the robot, for example, a tire or track of the robot. Furthermore, the state may comprise a position of other objects, for example road users, in the environment of the robot (100). The optimization problem solved for training the machine learning system (60) may then, in particular, include secondary conditions that characterize a minimum distance of the robot to other objects.

The actuator (10), which is preferably disposed in the robot (100), can be a brake, a drive, or a steering of the robot (100), for example. The control signal (A) may then be determined such that the actuator or actuators (10) are driven such that the robot (100) moves along, for example, the centerline of the drivable area. Additionally, the actuator(s) (10) may be actuated such that a collision with other objects in the environment of the robot (100) is avoided.

Alternatively or additionally, the control signal (A) can be used to control the display unit (10a) and, for example, display the identified objects and/or the planned travel trajectory of the robot (100).

Alternatively, the at least semiautonomous robot may also be another mobile robot (not shown), e.g., one that moves by flying, swimming, diving, or walking. For example, the mobile robot may also be an at least semiautonomous lawnmower or an at least semiautonomous cleaning robot. Even in these cases, the control signal (A) can be determined in such a way that drive and/or steering of the mobile robot are controlled in such a way that the at least semiautonomous robot prevents, for example, a collision with objects identified by the machine learning system (60).

FIG. 5 shows an embodiment example in which the control system (40) is used to control a manufacturing machine (11) of a manufacturing system (200) by controlling an actuator (10) that controls said manufacturing machine (11). The manufacturing machine (11) can, for instance, be a machine for punching, sawing, drilling and/or cutting. It is also conceivable that the manufacturing machine (11) is configured to grab a manufactured product (12a, 12b) by means of a gripper.

The sensor (30) can then be a video sensor, for example, that senses the conveying surface of a conveyor belt (13), for instance, wherein manufactured products (12a, 12b) can be located on the conveyor belt (13).

The state (x) may in particular comprise a position of a manufacturing product (12a, 12b) and a position of a machining tool of the manufacturing machine (11), e.g. a position of a gripper. The actuator (10) controlling the manufacturing machine (11) can then be controlled depending on the ascertained positions of the manufactured products (12a, 12b). The actuator (10) can be controlled such that it punches, saws, drills and/or cuts a manufactured product (12a, 12b) at a predetermined location on the manufactured product (12a, 12b), for instance.

Furthermore, it is conceivable that the machine learning system (60) is designed to determine further properties of a manufacturing product (12a, 12b) as an alternative or in addition to the position. It is in particular conceivable that the machine learning system (60) ascertains whether a manufactured product (12a, 12b) is defective and/or damaged. In this case, the actuator (10) can be controlled such that the manufacturing machine (11) rejects a defective and/or damaged manufactured product (12a, 12b).

The term “computer” comprises any device for processing specifiable calculation rules. These calculation rules can be provided in the form of software or in the form of hardware or also in a mixed form of software and hardware.

A plurality can be generally be understood as being indexed, i.e. each element of the plurality is allocated a unique index, preferably by allocating consecutive whole numbers to the elements included in the plurality. If a plurality N comprises elements, wherein N is the number of elements in the plurality, the elements are preferably allocated whole numbers from 1 to N.

1. A computer-implemented method for training a machine learning system for use in model predictive control of a technical system, wherein the machine learning system is configured to determine, with respect to an operating state and/or an environmental state of the technical system to be controlled, a value that characterizes a quality of said state, the method comprising:
determining a plurality of operating states and/or environmental states of the technical system to be controlled;
determining a quality value (Vᵢ) of a state (xᵢ) of the plurality of operating states and/or environmental states, wherein the quality value (Vᵢ) characterizes a quality of the state (xᵢ) with respect to a model predictive control; and
training the machine learning system through supervised training of the machine learning system, wherein the state (xᵢ) is used as input to the machine learning system and the determined quality value (Vᵢ) is used as desired output of the machine learning system.

2. The method according to claim 1, wherein the quality value (Vᵢ) is determined based on a value function of the model predictive control, wherein the value function determines a quality of the state (xᵢ) relating to a state (xᵢ) and the value function further comprises secondary conditions, and wherein a secondary condition characterizes a physical constraint of the state and/or a secondary condition characterizes a constraint of a control signal that can select the model predictive control.

3. The method according to claim 2, wherein the value function characterizes the result of an optimization of a cost function under the secondary conditions.

4. The method according to claim 2, wherein the value function comprises a secondary condition that permits a numerical deviation of a state (xᵢ) from a physical constraint by way of a slip variable.

5. The method according to claim 4, wherein the secondary condition further provides a factor that enhances the physical constraint of the state.

6. The method according to claim 2, wherein in the step of training, the machine learning system is trained at least until an approximation quality criterion is satisfied, and wherein the approximation quality criterion characterizes an amount of a difference of a value determined for a state of the value function and a value determined for the state of the machine learning system.

7. A computer-implemented method for model predictive control of a technical system, comprising:
determining an operating state and/or an environmental state of the system;
determining a control signal (A) for the system, wherein the control signal (A) is determined based on a policy (π), wherein the policy (π) comprises a term \tilde{V}(f(x,u)), wherein \tilde{V} characterizes an output of a machine learning system, when it receives the input f(x,u), wherein f is a linear model of the system, and predicts a next operating state and/or system state of the system u based on the determined operating state and/or environmental state x and a control signal, and wherein the machine learning system has been further trained according to the method of claim 1; and
controlling the system using the determined control signal.

8. The method according to claim 7, wherein the policy further comprises a term characterizing a magnitude of the control signal.

9. The method according to claim 1, wherein the machine learning model is or comprises a neural network.

10. A training device which is configured to carry out the method according to claim 1.

11. A control system set up to carry out the method according to claim 7.

12. A computer program, which is configured to carry out the method according to claim 1 when it is executed by a processor.

13. A machine-readable storage medium on which the computer program according to claim 12 is stored.
